(19) United States
(12) Patent Application Publication
(10) Pub. No.: US 2018/0140105 A1
(43) Pub. Date: May 24, 2018

(54) RESILIENT UNIT AND METHOD OF MANUFACTURE

(71) Applicant: Harrison Spinks Components Limited, West Yorkshire (GB)

(72) Inventor: Simon SPINKS, Yorkshire (GB)

(73) Assignee: Harrison Spinks Components Limited

(21) Appl. No.: 15/570,414

(22) PCT Filed: Apr. 28, 2016
(86) PCT No.: PCT/GB2016/051215

§ 371 Date: Oct. 30, 2017

(30) Foreign Application Priority Data
Apr. 28, 2015 (GB) 1507188.9

(51) Int. Cl. A47C 27/06; B68G 7/05; A47C 31/10

(52) U.S. Cl. CPC A47C 27/064; A47C 27/062; A01K 1/0353; A47C 31/105; B68G 7/05

(57) ABSTRACT

A resilient unit is shown generally at 10, and comprises a structural portion (12) and a support portion (14). The structural portion is formed by rows of large pocketed metallic coil springs (16). In particular two rows of slightly longer pocketed springs (16a) form the side walls (S) of the structural portion, whilst an array of slightly shorter ones (16b) form a base (B) of the structural portion. The support portion (14) is formed of a pocketed spring unit (18) comprising a plurality of metal coil springs individually encased in pockets formed by layers of thermally weldable, non-woven material that are joined together at locations between the springs. The raised side walls (S) formed by the rows of tall springs (16a) form a recess within which the pocketed spring unit (18) rests on the springs of the base (B). No adhesive is used in the resilient unit (10). The tall springs are formed in rows by welding layers of the pocket material together along seams that run axially beside the springs. The rows themselves are then joined by thermally welding together their edges and/or their ends, or by welding a common layer of material across the ends of the pocketed springs. The spring unit (18) is loosely rested upon the base so that it may be removed and replaced with another, similar unit of a different gauge, or combined with such another unit.

The present invention relates to a resilient unit and to a method of manufacturing a resilient unit, and is concerned particularly although not exclusively with a mattress and with a method of manufacturing a mattress.

The present invention is defined in the attached independent claims, to which reference should now be made. Further, preferred features may be found in the sub-claims appended thereto.

According to one aspect of the present invention, there is provided a resilient unit, for a mattress or the like, comprising a structural portion for providing shape and structure to the unit, and one or more support portions, for supporting a person or an object in use, the one or more support portions being arranged upon and/or within the structural portion, wherein the structural portion and the or each support portion comprise only pocketed spring units.

The resilient unit may be in the form of a pad.

One or more of the pocketed spring units may comprise a spring encased within a pocket of material. At least some of the pocketed spring units, and preferably at least some of the pocketed spring units of the or each support portion, may be of a first type comprising springs located in pockets formed from layers of material overlying the ends of the springs that are joined together at least at locations between the springs. The springs are preferably encased in individual pockets. The springs are preferably coil springs and are more preferably metallic coil springs. In a preferred arrangement at least some of the pocketed spring units comprise an array of springs encased within individual pockets.

Preferably there is a plurality of support portions which portions may be interchangeable within and/or upon the structural portion. At least some of the support portions may be interchangeable so as to alter at least one characteristic of the resilient unit. In a preferred arrangement at least some of the support portions are interchangeable so as to alter a resilient characteristic of the resilient unit.

The structural portion may also comprise one or more pocketed spring units of the first type. Alternatively, or in addition, the structural unit may comprise one or more pocketed spring units of a second type, comprising a row of springs individually encased within pockets, wherein the pockets are formed from layers of material overlying the sides of the springs that are joined together along an axially extending seam.

The structural portion may comprise at least one base portion, and at least one wall portion. In a preferred arrangement the structural portion comprises at least two, preferably four, wall portions arranged so as to stand substantially upright in use, and at least one base portion arranged so as to extend between at least two of the walls, and to be substantially horizontal in use. The base portion may be divided by a partition to provide at least two distinct zones. The partition may comprise part of the structural portion.

The zones either side of the partition may have a different characteristic, and in particular may have a different resilient characteristic. The support units may be arrangeable differently either side of the partition so as to provide the different characteristics.

At least one of the support units may be arranged to provide a different characteristic, and more particularly a different resilient characteristic, according to its orientation.

In a particularly preferred arrangement the structural portion has a generally H-shaped profile when viewed from an end.

In a preferred arrangement the material of the pockets of at least some, preferably a majority, and more preferably of all, of the pocketed spring units comprises thermally bondable material, more preferably non-woven thermally bondable material, that is thermally bonded to form the pockets. At least some, preferably a majority and more preferably substantially all, of the pocketed spring units may therefore be free of adhesive.

Preferably there is provided a cover for the resilient unit, which cover comprises a first cover portion for an upper surface of the resilient unit and a second cover portion for a lower surface of the resilient unit. The first and second cover portions may be arranged to be connected.

Preferably the first and second cover portions are arranged in use to be connected along at least one side wall of the structural portion.

In a particularly preferred arrangement the first and second cover portions are arranged in use to be connected along at least one side wall of the structural portion such that, when connected, a gap exists between the first and second cover portions.

The gap may be provided for ventilation of the interior of the resilient unit in use. The gap may be arranged in use to render at least a portion of the interior of the resilient unit visible to a viewer standing beside the resilient unit.

The first and second cover portions may be connectable, and preferably releasably connectable, by connector elements, which may comprise elastic connector elements.

Alternatively, or in addition, the cover may comprise a sleeve including at least one sleeve panel, wherein the sleeve panel comprises a pocketed spring unit. The sleeve panel may comprise a pocketed spring unit comprising a plurality of springs located in pockets formed from layers of material overlying the ends of the springs that are joined together at least at locations between the springs. The springs are preferably encased in individual pockets. The springs are preferably coil springs and are more preferably metallic coil springs.

The sleeve may comprise a plurality of sleeve panels and preferably comprises sleeve panels for overlying upper and/or lower surfaces of the resilient unit and/or side and/or end walls of the resilient unit.

The resilient unit may comprise a mattress for a bed, or may comprise another type of unit for providing comfort, convenience, support or protection to a person, animal or an object.

The invention also provides a method of manufacturing a resilient unit in the form of a pad, for a mattress or the like, comprising providing a structural portion for shape and structure, and providing one or more support portions, for supporting a person or an object in use, the method comprising arranging one or more support portions upon or within the structural portion, wherein the structural portion and the or each support portion comprise only pocketed spring units.

The method may comprise providing a plurality of support portions which portions may be interchangeable within or upon the structural portion. At least some of the support portions may be interchangeable so as to alter at least one characteristic of the resilient unit. In a preferred arrangement at least some of the support portions are interchangeable so as to alter a resilient characteristic of the resilient unit.

The method may comprise constructing the structural portion from at least one base portion, and at least one wall portion. In a preferred arrangement the method comprises constructing the structural portion from at least two, preferably four, wall portions arranged to stand substantially upright in use, and arranging at least one base portion between at least two of the walls, so as to be substantially horizontal in use. The method may include dividing the base portion by a partition to provide at least two distinct zones. The partition may comprise part of the structural portion.

Preferably the method includes providing a cover for the resilient unit, which cover comprises a first cover portion for an upper surface of the resilient unit and a second cover portion for a lower surface of the resilient unit. The method may include connecting the first and second cover portions. Preferably the method includes connecting the first and second cover portions along at least one side wall of the structural portion. In a particularly preferred arrangement the first and second cover portions are connected along at least one side wall of the structural portion such that a gap exists between the first and second cover portions.

Method may include connecting the first and second cover portions by connector elements, which may be elastic connector elements.

In another aspect there is provided a resilient unit, suitable for a mattress or similar, comprising only a plurality of springs encased in pockets formed from layers of material thermally bonded together.

Preferably at least some, and more preferably substantially all, of the springs are encased within individual pockets formed from material bonded thermally at positions between the springs.

The resilient unit may comprise at least one major surface arranged to support an object or a person in use. Preferably the at least one major surface comprises a layer of thermally bondable material that also encases at least some of the pocketed springs.

The resilient unit may comprise a mattress for a bed, or may comprise another type of unit for providing comfort, convenience, support or protection to a person, animal or an object.

In another aspect the present invention comprises a cover for a mattress or resilient unit, the cover comprising a sleeve including at least one sleeve panel, wherein the sleeve panel comprises a pocketed spring unit.

The sleeve panel may comprise a pocketed spring unit comprising a plurality of springs located in pockets formed from layers of material overlying the ends of the springs that are joined together at least at locations between the springs. The springs are preferably encased in individual pockets. The springs are preferably coil springs and are more preferably metallic coil springs.

The sleeve may comprise a plurality of sleeve panels and preferably comprises sleeve panels for overlying upper and/or lower surfaces of the resilient unit and/or side and/or end walls of the resilient unit.

The invention may include any combination of the features or limitations referred to herein, except such a combination of features as are mutually exclusive, or mutually inconsistent.

A preferred embodiment of the present invention will now be described, by way of example only, with reference to the accompanying diagrammatic drawings, in which:

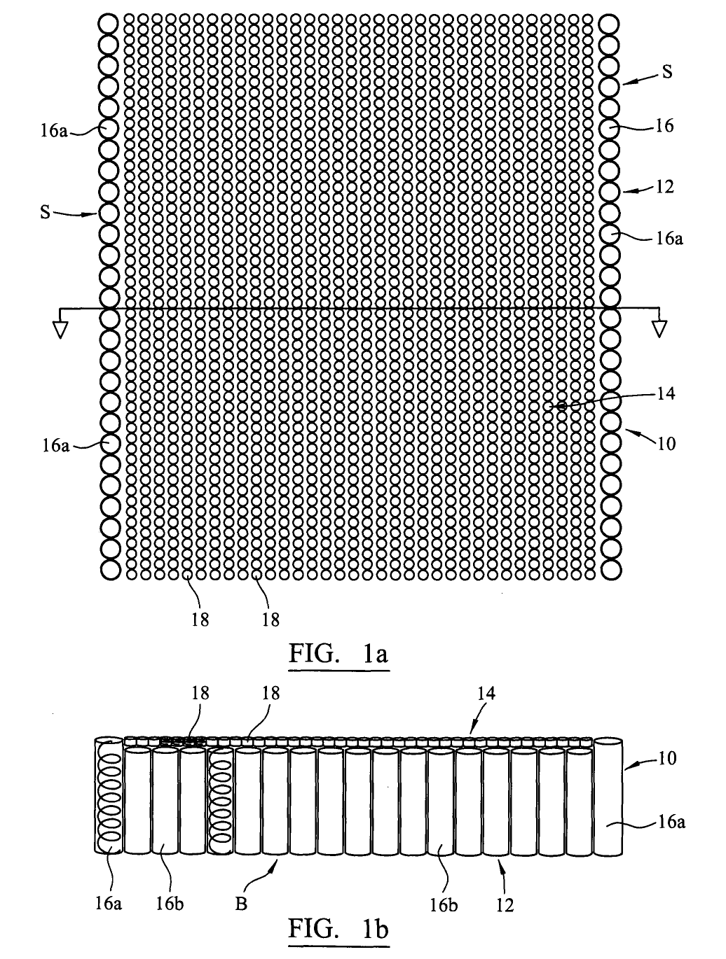

FIGS. 1a and 1b show, respectively in plan and cross-section, a first embodiment of resilient unit according to the present invention;

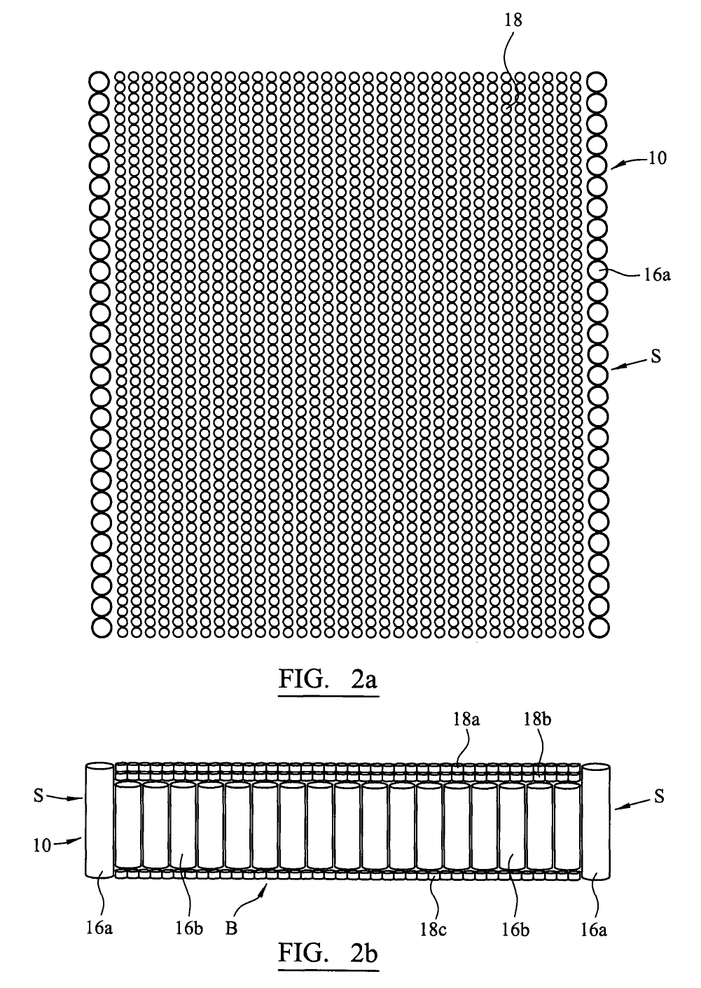

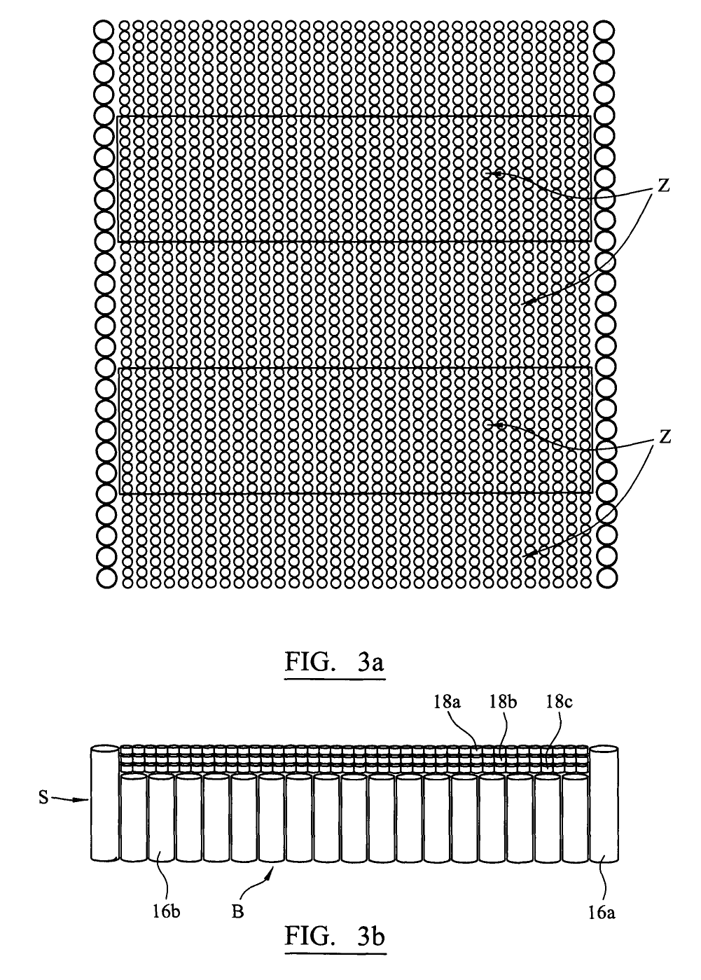

FIGS. 2a and 3b show, respectively in plan and cross-section a second embodiment of resilient unit according to the present invention;

FIGS. 3a and 3b show, respectively in plan and cross-section a third embodiment of the present invention;

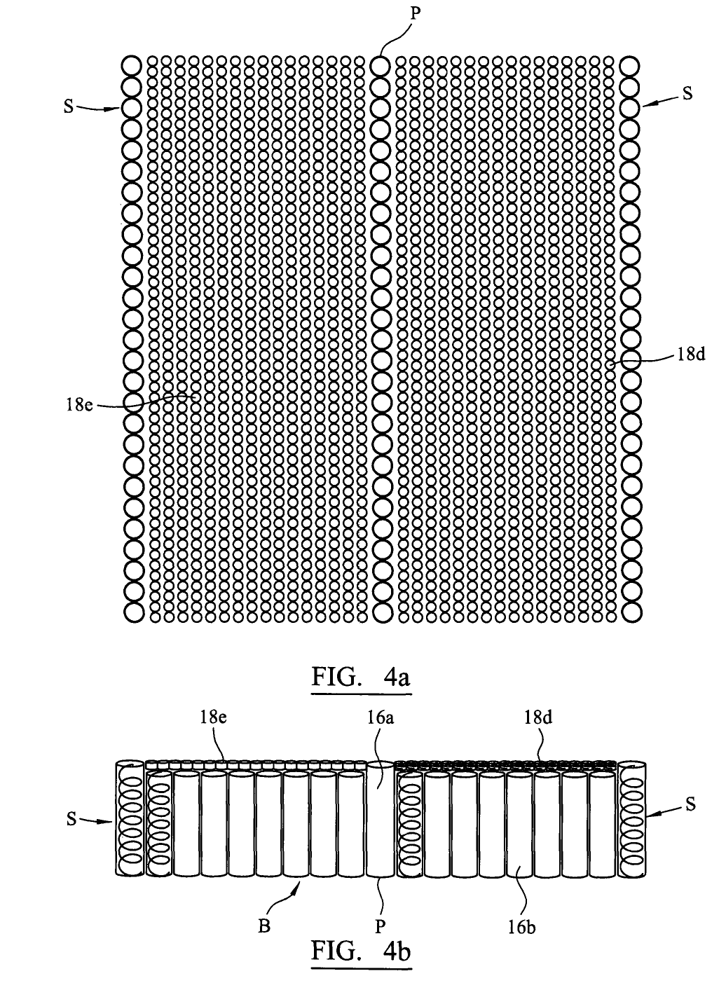

FIGS. 4a and 4b show respectively a fourth embodiment of resilient unit according to the present invention;

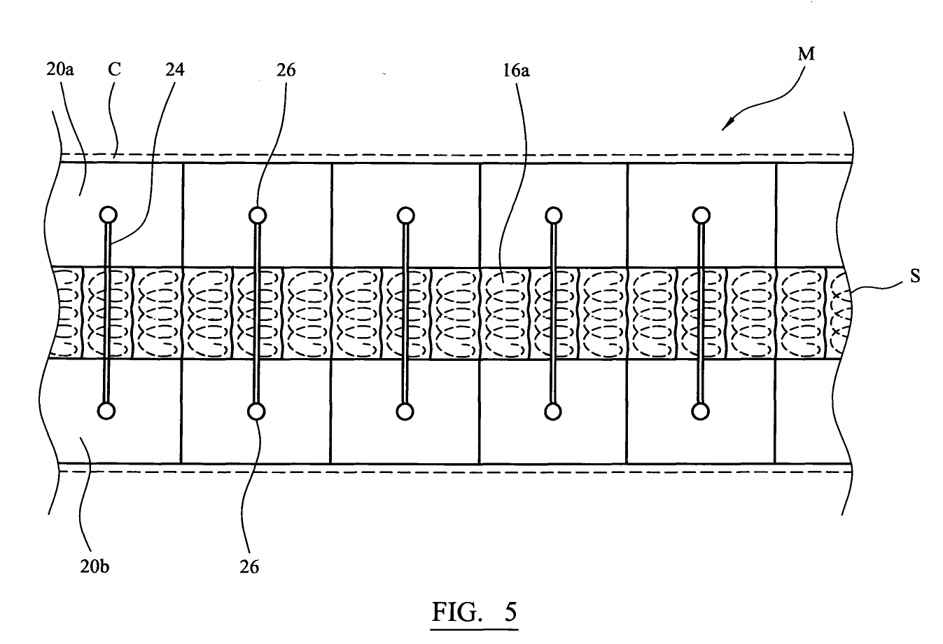

FIG. 5 is a side view of a mattress incorporating a resilient unit according to one of the embodiments of FIGS. 1 to 4;

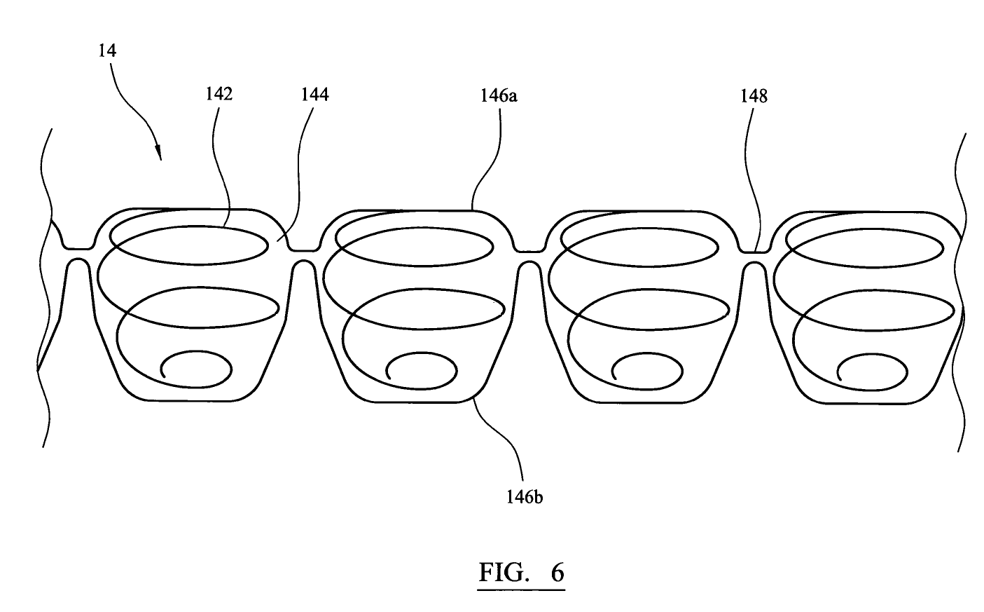

FIG. 6 shows in schematic sectional view a portion of a pocketed spring unit of a type used in a support portion of the mattress;

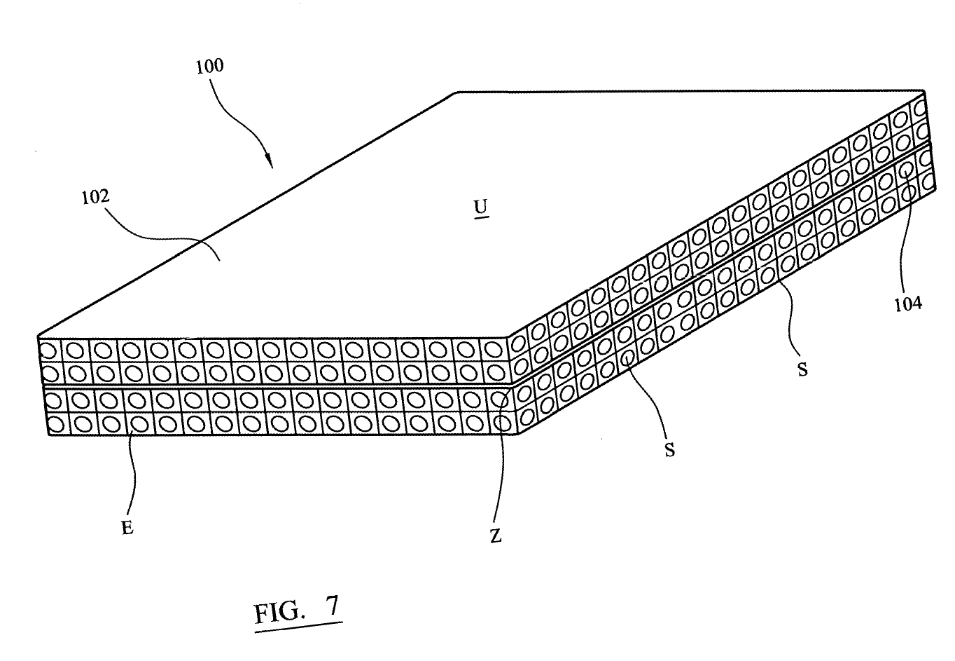

FIG. 7 shows a mattress sleeve of a first type; and

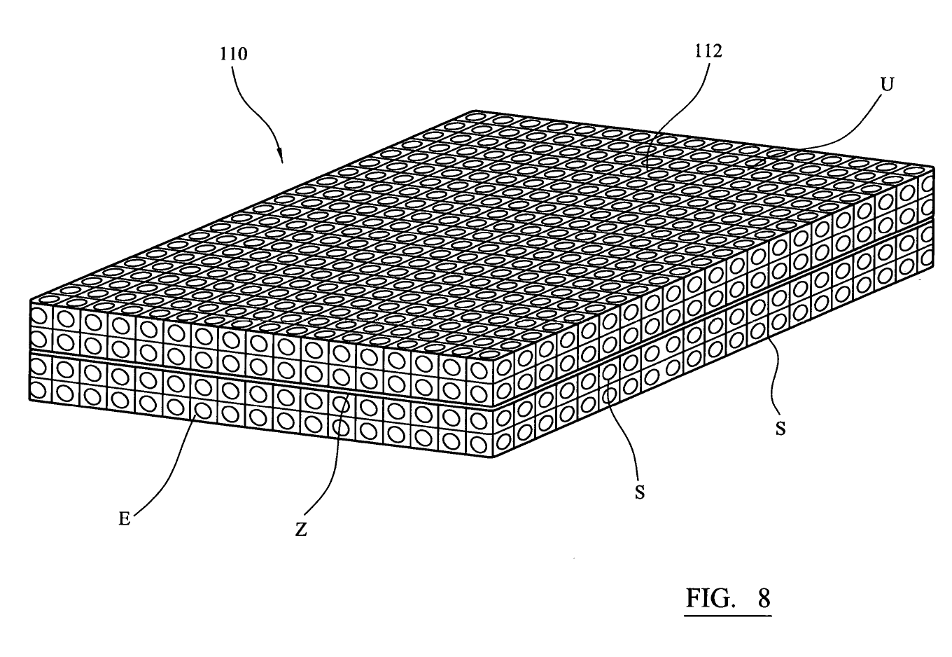

FIG. 8 shows a mattress sleeve of a second type.

Turning to FIGS. 1a and 1b, these show, respectively in plan view and in cross sectional view a resilient unit according to a first embodiment of the present invention. The resilient unit is of a size and shape that is suitable for it to be used as a mattress for a bed. However, the resilient units described herein can readily be made in other shapes and sizes for other uses including, but not limited to, seat bases and backs, exercise mats, flooring and support tables.

The resilient unit is shown generally at 10, and comprises a structural portion 12 and a support portion 14. The structural portion is formed by rows of large pocketed metallic coil springs 16. In particular two rows of slightly longer pocketed springs 16a form the side walls S of the structural portion, whilst an array of slightly shorter ones 16b form a base B of the structural portion.

The support portion 14 is formed of a pocketed spring unit comprising a plurality of metal coil springs individually encased in pockets formed by layers of thermally weldable, non-woven material that are joined together at locations between the springs. Our European Patent Number EP 1993974 B describes one method of making such a spring unit.

Some of the individual springs are shown in the drawing to indicate their position. However the springs would not normally be visible unless the material encasing them was transparent or translucent.

The raised side walls S formed by the rows of tall springs 16a form a recess within which the pocketed spring unit 18 rests on the springs of the base B.

No adhesive is used in the resilient unit 10. The tall springs are formed in rows by welding layers of the pocket material together along seams that run axially beside the springs. The rows themselves are then joined by thermally welding together their edges and/or their ends, or by welding a common layer of material across the ends of the pocketed springs. The spring unit 18 is loosely rested upon the base so that it may be removed and replaced with another, similar unit of a different gauge, or combined with such another unit.

FIGS. 2a and 2b show an alternative embodiment in the same views. Like components are labelled accordingly. In this embodiment the springs 16a forming the side walls S project beyond the base B both above and below, so that a mattress is formed that can be inverted to provide different characteristics, such as a different resilience or stiffness. On an upper side of the base B there are two superposed spring units 18a and 18b, whereas below the base B there is only a single spring unit 18c.

FIGS. 3a and 3b show an embodiment wherein the depth of the base B is further below the side walls S so that a deeper recess is formed that can accommodate three spring units 18a, 18b and 18c. The units 18a, 18b and 18c forming the support portion can be interchanged to provide differing levels of firmness. For example the gauge of the wire used in the springs can be different, or the geometry of the springs can be different within the distinct units 18a, 18b and 18c, so that the order in which they are placed on the base B causes a user to experience different firmness. In this embodiment the support is also made up of spring units whose characteristics vary in zones Z along the length of the mattress. The zones Z may comprise regions in which the spring units have different stiffness, and/or they may be areas in which the material of the upper layer forming the pockets has different characteristics, such as thermal or tactile characteristics. Our International patent application No. PCT/GB2013/052131 describes such spring units.

FIGS. 4a and 4b show a further embodiment in which the base B of the structural portion is divided lengthways by a further row of taller springs 16a forming a partition P. The support portion is also then divided into two, with one spring unit 18d on one side of the partition and another spring unit 18e on the other side of the partition. This allows the choice of firmness for the two sides of the mattress to be different, for example to accommodate users of different mass.

FIG. 5 shows a further embodiment of the invention, in this case in the form of a mattress M, in which a cover C is arranged over the resilient unit. The cover C comprises an upper cover part 20a and a lower cover part 20b. The two cover parts 20a and 20b are attached by means of releasable elastic ties 24 which fit through rings 26 at spaced intervals along the length of the mattress M. The springs 16a of the structural portion 12, forming the side wall S, are partly visible between the edges of the upper and lower cover portions 20a and 20b. This is because the cover is designed to leave a gap between the portions 20a and 20b so as to encourage ventilation of the resilient unit within.

Turning to FIG. 6, this shows schematically a part of a pocketed spring unit of the type that is used in the support portion 14. The unit comprises a plurality of metal coil springs 142 individually encased in pockets 144 formed by upper and lower layers 146a and 146b of thermally weldable, non-woven material, that are joined together at locations 148 between the springs, by welding the layers together. The individual springs are shown in the drawing to indicate their position. However the springs would not normally be visible unless the material encasing them was transparent or translucent.

The resilient unit described herein has a number of advantages over previously known resilient units, pads or mattresses. Firstly, the characteristics of the resilient unit can be varied by rearranging, and in some cases interchanging, the individual components. For example, the pocketed spring units forming the support portion can be rearranged to provide different levels of firmness. In addition, the material forming those pocketed spring units can be selected to provide different thermal or tactile characteristics. For example, one of the pocketed spring units 18 may have pocketing material that provides extra insulation, or a greater degree of comfort or luxury. Our previously mentioned our co-pending International patent application No. PCT/GB2013/052131 describes pocketed spring units that have upper and lower layers of material of different types and characteristics. Spring units can thus be inverted to provide a different “feel” to the resilient unit. This is particularly useful when the resilient unit is used as a mattress. It also means that there is no need to provide any additional comfort layer or ticking over the mattress, and because the individual spring units are removable and replaceable, there is no need to provide protective layers beneath.

The springs of the pocketed spring units can be formed from different gauges of wire, and can also be of different diameters, so that different spring densities can be combined to “tailor” a mattress to the needs of a particular user, or partners with different requirements who will share the mattress. Using methods described in our European patent No. EP 1993974 B, for example, spring densities upwards of 330 springs per square metre are particularly suitable for spring units used in the support portion 14.

The resilient unit and method of manufacture and assembly described above allow the mattress to be fully serviceable. This can include cleaning the product, as well as replacing certain items which have either worn out, or need changing as the user of the mattress changes in age and/or body shape. The mattress can then be easily and quickly disassembled at the end of its life, making recycling significantly easier than has been the case with previously considered mattresses.

Turning to FIG. 7, this shows a mattress generally at 100 with a mattress sleeve 102 thereon. The mattress sleeve 102 comprises sheets of thermally weldable, non-woven material on upper and lower surfaces U, S, of the mattress, with a substantially continuous pocketed spring unit 104 extending around side walls S and end walls W of the mattress. A zip Z allows upper and lower halves of the sleeve 102 to be at least partly separated to allow the sleeve to be removably positioned on the mattress 100. The pocketed spring unit 104 has the general structure described above with reference to FIG. 6.

FIG. 8 shows a mattress 110 covered by an alternative embodiment of mattress sleeve 112. In this embodiment the upper and lower surfaces U, S, of the mattress 110 as well as the side and end walls S, E are all covered by panels comprising pocketed spring units of the kind described above with reference to FIG. 6.

The mattress sleeves 102 and 112 can be used with conventional mattresses or resilient units of the kind described above, with reference to FIGS. 1 to 4.

Whilst endeavouring in the foregoing specification to draw attention to those features of the invention believed to be of particular importance, it should be understood that the applicant claims protection in respect of any patentable feature or combination of features referred to herein, and/or shown in the drawings, whether or not particular emphasis has been placed thereon.

1. A resilient unit, for a mattress or the like, comprising a structural portion for providing shape and structure to the unit, and one or more support portions, for supporting a person or an object in use, the one or more support portions being arranged upon and/or within the structural portion, wherein the structural portion and the or each support portion comprise only pocketed spring units.

2. A resilient unit according to claim 1, wherein one or more of the pocketed spring units comprises a spring encased within a pocket of material.

3. A resilient unit according to claim 1, wherein at least some of the pocketed spring units are of a first type comprising springs located in pockets formed from layers of material overlying the ends of the springs that are joined together at least at locations between the springs. In a preferred arrangement at least some of the pocketed spring units comprise an array of springs encased within individual pockets.

4. A resilient unit according to claim 1, wherein there is a plurality of support portions which portions are interchangeable within and/or upon the structural portion.

5. A resilient unit according to claim 4, wherein at least some of the support portions are interchangeable so as to alter at least one characteristic of the resilient unit.

6. A resilient unit according to claim 3, wherein the support portion comprises one or more pocketed spring units of the first type.

7. A resilient unit according to claim 3, wherein the structural unit comprises one or more pocketed spring units of the first type.

8. A resilient unit according to claim 3, wherein the structural unit comprises one or more pocketed spring units of a second type, comprising a row of springs individually encased within pockets, wherein the pockets are formed from layers of material overlying the sides of the springs that are joined together along an axially extending seam.

9. A resilient unit according to claim 1, wherein the structural portion comprises at least one base portion, and at least one wall portion.

10. A resilient unit according to claim 9, wherein the structural portion comprises at least two, preferably four, wall portions arranged so as to stand substantially upright in use, and at least one base portion arranged so as to extend between at least two of the walls, and to be substantially horizontal in use.

11. A resilient unit according to claim 9 or 10, wherein the base portion is divided by a partition to provide at least two distinct zones.

12. A resilient unit according to claim 11, wherein the zones either side of the partition may have a different characteristic, and in particular have a different resilient characteristic.

13. A resilient unit according to claim 11, wherein the support units may be arrangeable differently either side of the partition so as to provide the different characteristics.

14. A resilient unit according to claim 1, wherein at least one of the support units is arranged to provide a different characteristic, and more particularly a different resilient characteristic, according to its orientation.

15. A resilient unit according to claim 1, wherein the structural portion has a generally H-shaped profile when viewed from an end.

16. A resilient unit according to claim 1, wherein there is provided a cover for the resilient unit, which cover comprises a first cover portion for an upper surface of the resilient unit and a second cover portion for a lower surface of the resilient unit.

17. A resilient unit according to claim 16, wherein the first and second cover portions are arranged to be connected.

18. A resilient unit according to claim 16, wherein the first and second cover portions are arranged in use to be connected along at least one side wall of the structural portion.

19. A resilient unit according to claim 16, wherein the first and second cover portions are arranged in use to be connected along at least one side wall of the structural portion such that, when connected, a gap exists between the first and second cover portions.

20. A resilient unit according to claim 16, wherein the first and second cover portions are releasably connectable, by connector elements.

21. A resilient unit according to claim 16, wherein the cover comprises a sleeve including at least one sleeve panel, wherein the sleeve panel comprises a pocketed spring unit.

22. A resilient unit according to claim 1, wherein the resilient unit comprises a mattress for a bed, or another type of unit for providing comfort, convenience, support or protection to a person, animal or an object.

23. A method of manufacturing a resilient unit, for a mattress or the like, comprising providing a structural portion for shape and structure, and providing one or more support portions, for supporting a person or an object in use, the method comprising arranging one or more support portions upon or within the structural portion, wherein the structural portion and the or each support portion comprise only pocketed spring units.

24. A method according to claim 23, wherein the method comprises providing a plurality of support portions which portions may be interchangeable within or upon the structural portion.

25. A resilient unit, suitable for a mattress or similar, comprising only a plurality of springs encased in pockets formed from layers of material thermally bonded together.

26. A cover for a mattress or resilient unit, the cover comprising a sleeve including at least one sleeve panel, wherein the sleeve panel comprises a pocketed spring unit.

27. A cover according to claim 26, wherein the sleeve panel comprises a pocketed spring unit comprising a plurality of springs located in pockets formed from layers of material overlying the ends of the springs that are joined together at least at locations between the springs. The springs are preferably encased in individual pockets. The springs are preferably coil springs and are more preferably metallic coil springs.

28. A cover according to claim 26, wherein the sleeve comprises sleeve panels for overlying upper and/or lower surfaces of the resilient unit and/or side and/or end walls of the resilient unit.
